(19) United States
(12) Patent Application Publication
(10) Pub. No.: US 2008/0101733 A1
(43) Pub. Date: May 1, 2008

(54) Stand-Up Pouch Having Optimised Tear-Open Behaviour, and Method for the Production Thereof

(76) Inventors: Christian Fenn-Barrabass, Oberguenzburg (DE); Walter Guenter, Eddigehausen (DE); Josef Mueller, Eggolishelm (DE)

Correspondence Address: WELSH & KATZ, LTD, 120 S RIVERSIDE PLAZA, 22ND FLOOR, CHICAGO, IL, 60606, US

(21) Appl. No.: 11/596,776

(22) PCT Filed: May 13, 2005
(86) PCT No.: PCT/EP05/05290

§ 371 Date: Oct. 16, 2007

(30) Foreign Application Priority Data
May 17, 2004 (DE) 10 2004 024 348.4
Jun. 3, 2004 (DE) 10 2004 026 980.7

(51) Int. Cl. B65D 30/16; B31B 1/00; B65D 65/28

(52) U.S. Cl. 383/104; 383/207; 493/267

(57) ABSTRACT

The invention relates to a stand-up pouch having a stand-up pouch body and a stand-up pouch base, especially a standing base, wherein at least the stand-up pouch body comprises at least one unidirectionally stretched film. The invention furthermore describes a method for the production of such a stand-up pouch.

### DESCRIPTION

The invention relates to a stand-up pouch and to a method for the production thereof, in accordance with the preambles of patent claims 1 and 13.

Stand-up pouches of the kind mentioned are widely used as substitutes for bags, as well as bottles, tins and cartons, for the packaging of solid, liquid and paste-like foods and consumables and also for utility products of all kinds.

Stand-up pouches have numerous advantages over the above-mentioned conventional packagings: there may be mentioned, firstly, their low weight, their excellent storability accompanied by simplicity and economy of manufacture as well as their unproblematic disposal.

However, when using stand-up pouches, their frequently poor opening behaviour has been found to be disadvantageous, the stand-up pouch often being uncontrollably torn open once an initial tear has been made in the stand-up pouch, for example with the aid of a notch, resulting in destruction of the stand-up pouch and in spillage of the contents of the pouch. Further use of the opened stand-up pouch is completely impossible.

Numerous aids such as, for example, tear-open threads, perforations or the utilisation of scissors or knives have been used or recommended as a solution to that problem; however, these in turn have required laborious and expensive manufacturing and production methods or necessitated additional implements that are not always to hand.

In that regard there is a great need for a stand-up pouch which can be opened by simple means without being completely destroyed and without the whole stand-up pouch being torn open uncontrollably, and which is available for further use even after opening.

The problem of the invention is accordingly to make available a simple stand-up pouch which is economical to manufacture, having the afore-mentioned properties whilst avoiding the disadvantages of the prior art, and which in addition to its suitability for a wide variety of uses is made from a material that has a long service life and that can be disposed of without problems.

The problem is solved by a stand-up pouch according to patent claim 1 and by a method for the production thereof according to patent claim 13. In particular, the problem is solved by a stand-up pouch having a stand-up pouch body and a stand-up pouch base, especially a standing base, wherein at least the stand-up pouch body comprises at least one unidirectionally stretched film.

In this context it should be mentioned that within the framework of the invention a stand-up pouch is to be understood as any container formed from a film and/or laminate, especially including tubular pouches, with or without a separate or connected base part and/or shoulder part and/or lid part.

A fundamental aspect of the invention is that in a unidirectionally stretched film the molecule chains forming the film are oriented and are arranged substantially parallel in the stretching direction. As a result thereof, the stretched material preferentially splits parallel to the stretching direction as opposed to in a direction at an angle thereto, so that tearing into the material at an angle is made very difficult or impossible by the oriented molecule chains.

A further advantage in the use of a unidirectionally stretched film is that, when such a film is split or torn open parallel to the stretching direction, none of the molecule chains have to be severed or torn out from an association of molecules because the molecule chains forming the material are not convoluted but are arranged more or less straight, beside one another. As a result, tearing such a unidirectionally stretched film parallel to the stretching direction requires a greatly reduced tearing force compared to conventional films which is up to 50% to 60% below the tearing force that would be necessary for a conventionally non-stretched or bidirectionally stretched film.

In that respect, a stand-up pouch made from a unidirectionally stretched film, at least in a tear-open region, exhibits optimised tear-open behaviour compared to conventional stand-up pouches, with a straight and even tear edge which follows the stretching direction. In the case of such a stand-up pouch there is no need to fear that a tear will uncontrollably extend through the whole body of the stand-up pouch, so that even stand-up pouches with liquid contents can be torn open without problems and without having to fear any loss of the contents of the pouch.

In accordance with the invention, as mentioned hereinbefore, at least that part of the stand-up pouch body which is to be torn open is formed from at least one unidirectionally stretched film. For the sake of completeness, however, it should be mentioned that the entire stand-up pouch body and also the stand-up pouch stand-up base or standing base and the stand-up pouch lid and/or a shoulder part connected to the latter may also be made from such a unidirectionally stretched film.

In accordance with one embodiment, the unidirectionally stretched film is part of a laminate, which may comprise a barrier layer. In accordance with the invention, the unidirectional film comprises at least one polyolefin and/or ester, preferred materials being polyethylene and/or polypropylene and/or polyethylene terephthalate. The optional barrier layer can be made, for example, of ethyl vinyl alcohol (EVOH) or a metal vapour-deposited onto the laminate or used in the form of a foil. A further barrier layer material comprises, for example, glass-like substances, which may comprise SiO₂. The afore-mentioned materials may, in the case of polyethylene and/or polypropylene, be present in pure form but also as a co-extrudate and also in conjunction with polyethylene terephthalate.

As metal there comes into consideration, especially, aluminium, although depending on the application other, preferably corrosion-resistant, metals may also be used.

In accordance with the invention, the barrier layer is arranged on at least one sealable layer and is preferably embedded, for example between polyethylene terephthalate and polypropylene or polyethylene. Of course, a multilayer laminate having a plurality of barrier layers may also be provided, in which case preferably at least one of the outermost layers, especially the outermost layer, is sealable.

In accordance with the invention, the unidirectionally stretched film—there may also be plurality of unidirectionally stretched films—has a greater thickness relative to further layers of the laminate.

It is, moreover, within the framework of the invention for the thickness of the unidirectionally stretched film to be greater than that of the remaining further layers of the laminate, the thickness of a unidirectionally stretched film being in the range from 10 μm to 200 μm, preferably in the range from 35 μm to 155 μm and especially in the range from 45 μm to 95 μm.

By that means it is ensured that the tear-open behaviour of the stand-up pouch is clearly and decisively defined by the one or more unidirectionally stretched film(s).

It should be mentioned at this point that, for production of the stand-up pouch according to the invention, granulates can also be used which have very good tearing behaviour and a high melt flow index and a molecule structure oriented in accordance with the tear-open direction.

In accordance with a preferred embodiment, the stand-up pouch produced using the unidirectionally stretched film is sterilisable. In that case, polypropylene, preferably, is provided as film material, whereas for stand-up pouches which do not need to be sterilisable polyethylene is a preferred, economical and suitable material.

In accordance with one embodiment, the stand-up pouch body is extruded in tubular form or produced in lap-sealed or fin-sealed form, which contributes to an optimised round shape of the stand-up or tubular pouch body.

The stability of the stand-up pouch is decisively ensured by at least one unidirectionally stretched film, the use of polyethylene terephthalate decisively contributing to the mechanical stability and the use of polypropylene and/or polyethylene decisively contributing to the dimensional stability.

In accordance with an especially preferred embodiment of the invention there is provided on the stand-up pouch body, for example at a sealing seam, an initial tearing aid, especially a notch or like direction-defining weakening, by means of which further tearing-open of the stand-up pouch parallel to a unidirectional stretching direction of the unidirectionally stretched film can be initiated.

By means of an initial tearing or tear-open aid of a such a kind, appropriate initial tearing of the tubular pouch is ensured, the tearing pointer or notch which points in the direction of the stand-up pouch opening out into the opening seam to-be or leading to the opening split in the unidirectionally stretched film.

In principle it should be mentioned, however, that an initial tearing aid of such a kind is not imperative because the tearing force required to open the stand-up pouch is substantially reduced compared to conventional stand-up pouches and, for example, even a notch made by a finger-nail or some other article provided with an edge will, depending on the thickness of the film or laminate, allow the stand-up pouch to be torn open properly and cleanly with a clearly defined straight tear-line.

Accordingly, measures according to the prior art for facilitated tearing-open of a stand-up pouch such as the complicated incorporation of tear-open threads or tapes, or perforations (in that case having in mind punched holes or laser perforations with the accompanying disadvantages), in or on the laminate or film are no longer necessary. Accordingly, in the production of the stand-up pouch according to the invention, a considerable reduction in production and material costs is possible because conventional and extremely economical materials such as polyolefins and/or polyamides, for example polypropylene, polyethylene or polyethylene terephthalate, are entirely sufficient in order to produce a stretched film in accordance with the invention and, from that, a corresponding stand-up pouch with or without barrier layers.

The problem according to the invention is furthermore solved by a method for the production of a stand-up pouch, which method is characterised by the following steps:
a) production of a thick film;
b) stretching of the thick film in a unidirectional direction;
c) lamination of the unidirectionally stretched film;
d) formation of the stand-up pouch;
e) optional incorporation of a direction-defining weakening, especially an initial tearing aid, in the stand-up pouch, whereby initial tearing of the stand-up pouch parallel to a unidirectional stretching direction of the unidirectionally stretched film is made possible.

For production of the thick film, a polyolefin and/or polyamide such as, for example, polyethylene or polypropylene or a co-extrudate thereof is used. It is likewise possible to use polyethylene terephthalate for production of the thick film.

In accordance with an embodying variant, it is possible to carry out steps a) to c) simultaneously or quasi-simultaneously, especially in the course of a coextrusion procedure. In this case it is possible, directly during production of the laminate, to introduce a barrier layer on or between layers of the laminate.

It is likewise possible for the laminate to be produced, and especially extruded and, where appropriate, sealed, as a film in sheet form or as a fin-sealed or lap-sealed tube.

Further embodiments of the invention are to be found in the subordinate claims.

The invention will be described hereinbelow with reference to two exemplifying embodiments.

A stand-up pouch according to the invention is produced by first producing a thick film from each of polypropylene and polyethylene terephthalate. The polyethylene terephthalate thick film and the polypropylene thick film are unidirectionally stretched in the machine direction. Then, an aluminium layer having a layer thickness of 8 μm is applied to the stretched polypropylene film, which has a layer thickness of 70 μm. The afore-mentioned stretched polyethylene terephthalate layer, which has a thickness of 12 μm, is in turn laminated onto the aluminium layer.

The thereby produced laminate having a barrier property is formed into a tube by means of a lap-seal join so as to form a tubular pouch body, in the bottom of which a base part having a barrier property, for example a deep-drawn base part, is sealed. At the top, the tubular pouch is sealed by means of a fin seal. As a tearing-open aid, a notch is so arranged at a lower boundary of the fin seal that, on tearing open the tubular pouch, the top fin seal is removed and the tubular pouch opened. As a result of removing the top fin seal, which held together the top of the tubular pouch in the closed state, the tubular pouch can then regain its round tubular pouch body shape so that the level of the contents of the pouch then drops down a little as a result of the pouch becoming wider, and spillage of the contents of the pouch is additionally avoided as a result.

In accordance with a second exemplifying embodiment, a thick film is first produced from polypropylene, which is subsequently unidirectionally stretched in the running direction of the machine until a layer thickness of stretched polypropylene film of 70 μm is achieved. A further thick film of polyethylene terephthalate is also unidirectionally stretched in the machine direction until a layer thickness of stretched polyethylene terephthalate film of about 12 μm is achieved. From those two stretched films, together with an aluminium foil having a layer thickness of 8 pm arranged between them, there is produced a laminate in sheet form.

From that laminate, cut-outs of film for respective front and back sides of a stand-up pouch body are cut. The respective outside edges of the front and back sides of the laminate are sealed together over a width of about 3 mm. The base of the stand-up pouch is produced by sealing in place a cut-out having a V-shaped fold.

After filling, the top of the stand-up pouch is closed, for example by means of a fin seal. Furthermore, at the side of the fin seal there is incorporated an initial tearing aid in the form of a notch, by means of which further tearing-open of the stand-up pouch can be initiated.

The initial tearing aid can be provided on one side, or on both sides, of the stand-up pouch.

When the stand-up pouch is then to be opened, lateral tearing-open of the stand-up pouch is initiated at the notch, directionally defined tearing-open parallel to the stand-up base being ensured by means of the unidirectionally stretched films, that tearing-open requiring a substantially reduced further tearing force compared to the tearing-open of a conventional stand-up pouch.

If desired, an impression can be provided adjacent to the tear-open line predefined by the tear-open notch and the stretching direction.

At this point it should be stated that all above-described parts, considered on their own and in any combination, are claimed as being important for the invention. The skilled person will be familiar with modifications thereof.

1-14. (canceled)

15. A stand-up pouch comprising a stand-up pouch body and a stand-up pouch base, wherein at least the said stand-up pouch body comprises at least one unidirectionally stretched film.

16. A stand-up pouch according to claim 15, wherein said stand-up pouch base is a standing base.

17. A stand-up pouch according to claim 15, wherein said unidirectionally stretched film is part of a laminate.

18. A stand-up pouch according to claim 17, wherein said unidirectionally stretched film has a greater thickness relative to further layers of the laminate.

19. A stand-up pouch according to claim 17, wherein the thickness of said unidirectionally stretched film is greater than that of the remaining further layers of the laminate.

20. A stand-up pouch according to claim 15, wherein said at least one unidirectionally stretched film is selected from the group consisting of at least one polyolefin, at least one polyamide, at least one ester, polyethylene, polypropylene, polyethylene terephthalate, and two or more of the preceding materials.

21. A stand-up pouch according to claim 15, wherein stability of the stand-up pouch is decisively ensured by means of at least one unidirectionally stretched film.

22. A stand-up pouch according to claim 15, wherein said unidirectionally stretched film has a thickness selected from the group consisting of in the range from 10 μm to 200 μm, in the range from 35 μm to 155 μm, and in the range from 45 μm to 95 μm.

23. A stand-up pouch according to claim 17, wherein the laminate comprises at least one barrier layer.

24. A stand-up pouch according to claim 23, wherein said at least one barrier layer is selected from the group consisting of ethyl vinyl alcohol (EVOH), SiO₂, metal, aluminum, and two or more of the preceding materials.

25. A stand-up pouch according to claim 15, wherein said stand-up pouch is sterilizable.

26. A stand-up pouch according claim 15, wherein said stand-up pouch body has a form selected from the group consisting of extruded in tubular form, produced by means of a lap-seal, produced by means of a fin-seal, and produced by means of a lap-seal and a fin-seal.

27. A stand-up pouch according to claim 15, wherein there is provided on said stand-up pouch an initial tearing aid by means of which further tearing-open of the stand-up pouch generally parallel to a unidirectional stretching direction of the unidirectionally stretched film can be initiated.

28. A stand-up pouch according to claim 27, wherein said initial tearing aid comprises a notch or like direction-defining weakening.

29. A method for the production of a stand-up pouch according to claim 15, said method comprising the steps of:
a) production of a thick film;
b) stretching of said thick film In a unidirectional direction;
c) lamination of the unidirectionally stretched film;
d) formation of the stand-up pouch;
e) incorporation of a direction-defining weakening in the stand-up pouch, whereby initial tearing of the stand-up pouch generally parallel to a unidirectional stretching direction of the unidirectionally stretched film is made possible.

30. A method according to claim 29, wherein said direction-defining weakening is an initial tearing aid.

31. A method according to claim 29, wherein steps a) to c) are carried out simultaneously or quasi-simultaneously.

32. A method according to claim 31, wherein said steps a) to c) are carried out in the course of a coextrusion procedure.
